(19) United States
(12) Patent Application Publication
(10) Pub. No.: US 2025/0141372 A1
(43) Pub. Date: May 1, 2025

(54) MOTOR CONTROL METHOD

(71) Applicants: HYUNDAI MOTOR COMPANY, Seoul (KR); KIA CORPORATION, Seoul (KR)

(72) Inventor: Min Ho Chae, Incheon (KR)

(73) Assignees: HYUNDAI MOTOR COMPANY, Seoul (KR); KIA CORPORATION, Seoul (KR)

(21) Appl. No.: 18/613,996

(22) Filed: Mar. 22, 2024

(30) Foreign Application Priority Data
Oct. 31, 2023 (KR) 10-2023-0148286

(51) Int. Cl. H02P 5/74

(52) U.S. Cl. CPC H02P 5/74

(57) ABSTRACT

Proposed is a motor control method to control the phase angles of a first partial motor and a second partial motor. In particular, the first partial motor includes a first type 3-phase coil and the second partial motor includes a second type 3-phase coil. In a rotation speed region less than or equal to a predetermined reference rotation speed, the phase angles of the first and second partial motors are controlled to be equal. Meanwhile, the phase angles of the first partial motor and the second partial motor are controlled to be different from each other in a rotation speed region exceeding the reference rotation speed.

### CROSS REFERENCE TO RELATED APPLICATION

The present application claims priority to Korean Patent Application No. 10-2023-0148286, filed on Oct. 31, 2023, the entire contents of which are incorporated herein for all purposes by this reference.

### TECHNICAL FIELD

The present disclosure relates to a method for controlling a six (6)-phase motor that is used to drive a vehicle.

### BACKGROUND

A hybrid vehicle or an electric vehicle generates a driving force necessary for driving the vehicle by driving a motor with the electric power provided by a battery mounted on the vehicle.

The vehicle motor described above needs to be highly efficient in order to satisfy the fuel efficiency and power output of the vehicle.

The foregoing description as the background technology of the present disclosure is provided only to enhance understanding of the background of the present disclosure and should not be taken as a recognition of prior art known to those of ordinary skill in the art.

### SUMMARY

An objective of the present disclosure is to provide a motor control method for more effectively providing the power performance required by a vehicle by more effectively controlling a six (6)-phase motor where the number of three (3)-phase coil turns is different from the number of the remaining 3-phase coil turns.

The motor control method of the present disclosure may achieve the above objective by controlling a 6-phase motor, comprising a first type 3-phase coil and a second type 3-phase coil wound with a fewer number of turns than the first type 3-phase coil. The motor control method may control the phase angles of a first partial motor, comprising the first type 3-phase coil, and a second partial motor, comprising the second type 3-phase coil, to be equal when a rotation speed of the 6-phase motor is less than or equal to a predetermined reference rotation speed. Meanwhile, when the rotation speed of the 6-phase motor exceeds the reference rotation speed, the motor control method controls the phase angles of the first partial motor and the second partial motor to be different from each other.

The reference rotation speed may be set to a base rotation speed of the first partial motor.

In a region where the required output of the motor is less than or equal to a predetermined reference output, the output torques of the first partial motor and the second partial motor may be controlled to be equal. In a region where the required output of the motor exceeds the reference output, the output torques of the first partial motor and the second partial motor may be controlled to be different from each other.

The reference output may be set to an output corresponding to twice the maximum output of the first partial motor.

A driving region for driving only the second partial motor may be set to a rotation speed region higher than a driving region for driving only the first partial motor.

The first partial motor may include: the first type 3-phase coil disposed at equal intervals along the circumferential direction around the rotation shaft of the motor, and the second partial motor may include the second type 3-phase coil disposed at equal intervals in the circumferential direction around the rotation shaft of the motor.

The first type 3-phase coil may include an A-phase coil, a B-phase coil, and a C-phase coil, and the second type 3-phase coil may include an X-phase coil, a Y-phase coil, and a Z-phase coil. The A-phase coil, the B-phase coil, and the C-phase coil may be disposed sequentially in the circumferential direction of a stator. The X-phase coil, the Y-phase coil, and the Z-phase coil may be sequentially disposed along a direction in which the A-phase coil, the B-phase coil, and the C-phase coil are disposed.

The A-phase coil, the B-phase coil, the C-phase coil, the X-phase coil, the Y-phase coil, and the Z-phase coil may be disposed such that A-phase, X-phase, B-phase, Y-phase, C-phase, and Z-phase are repeatedly formed one by one along the circumferential direction of the stator.

The first type 3-phase coil and the second type 3-phase coil may include windings having different thicknesses.

In addition, the motor control method of the present disclosure controls a 6-phase motor with a first type 3-phase coil and a second type 3-phase coil wound with a fewer number of turns than the first type 3-phase coil. In particular, the motor control method may control output torques of a first partial motor, including a first type 3-phase coil, and a second partial motor, including a second type 3-phase coil, to be equal in a region where a required output of the motor is less than or equal to a predetermined reference output. In addition, the motor control method may control the output torques of the first partial motor and the second partial motor to be different from each other in a region where the required output of the motor exceeds the predetermined reference output.

The predetermined reference output may be set to an output corresponding to twice the maximum output of the first partial motor.

A driving region for driving only the second partial motor may be set to the rotation speed region higher than a driving region for driving only the first partial motor.

In a rotation speed region where a rotation speed of the 6-phase motor is less than or equal to a base rotation speed of the first partial motor, phase angles of the first partial motor and second partial motor may be controlled to be equal. In a rotation speed region where the rotation speed of the 6-phase motor exceeds the base rotation speed of the first partial motor, the phase angles of the first partial motor and the second partial motor may be controlled to be different from each other.

The present disclosure is to effectively provide the power performance required by a vehicle by more effectively controlling a 6-phase motor where the number of the 3-phase coil turns is different from the number of the remaining 3-phase coil turns.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view showing a structure of a heterogeneously wound 6-phase motor to which the present disclosure may be applied;

FIG. 2 is a view conceptually showing a 6-phase coil disposed in a stator of FIG. 1;

FIG. 3 is a view showing a driving circuit for driving a 6-phase motor of FIG. 1;

FIG. 4 is a graph showing the maximum output lines of a first partial motor and a second partial motor according to the present disclosure;

FIG. 5 is a graph comparing simulation results when the phase angles of the first partial motor and the second partial motor are controlled to be equal or to be different from each other; and

FIG. 6 is a graph explaining a motor control method according to the present disclosure.

### DETAILED DESCRIPTION OF THE DISCLOSURE

Hereinafter, embodiments disclosed in the present specification are described in detail with reference to the accompanying drawings, however, the same or similar components are assigned the same reference number regardless of drawing designation and overlapping descriptions thereof are omitted.

The suffixes “module” and “portion” for components used in the following description are given or used interchangeably in consideration of only ease of preparation of the specification and are not intended to have a distinct meaning or role in themselves.

In describing an embodiment disclosed in this specification, the detailed description is omitted when it is determined that the detailed description of the related known technology may obscure the gist of the embodiment disclosed in this specification. In addition, the accompanying drawings are only for easy understanding of the embodiments disclosed herein, and it is to be understood that the technical ideas disclosed herein are not limited by the accompanying drawings and include all modifications, equivalents, or substitutions that are within the scope of the ideas and technology of the present disclosure.

Terms including ordinal numbers, such as first and second, may be used to describe various components, but the components are not limited by the terms. These terms are used only for the purpose of distinguishing one component from another.

When it is stated that a component is “connected” or “linked” to another component, it should be understood that it may be directly connected to that other component, but there may be other components in between. On the other hand, when it is stated that one component is “directly connected” or “directly linked” to another component, it should be understood that there are no other components in between.

Singular expressions include plural expressions unless the context clearly indicates otherwise.

In this specification, terms such as “include” or “have” are intended to specify the presence of features, numbers, steps, actions, components, parts or combinations thereof described in the specification, and should be understood not to preclude the presence or addition of one or more other features or numbers, steps, actions, components, parts or combinations thereof. When a component, device, element, or the like, of the present disclosure, is described as having a purpose or performing an operation, function, or the like, the component, device, or element should be considered herein as being “configured to” meet that purpose or to perform that operation or function.

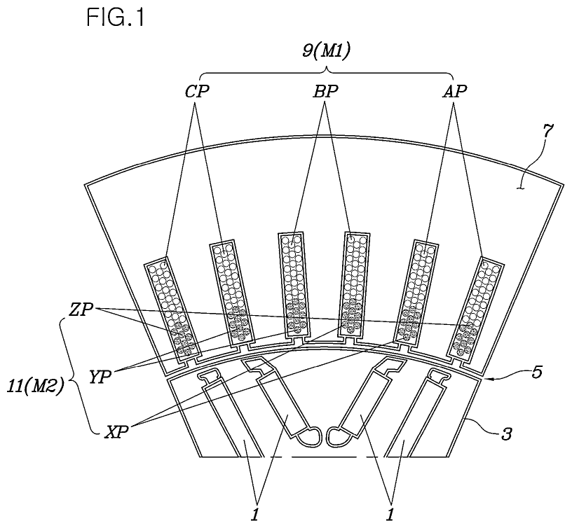

A structure of a heterogeneously wound 6-phase motor to which a motor control method of the present disclosure may be applied is described with reference to FIGS. 1-3.

Referring to FIG. 1, a rotor 3 equipped with a permanent magnet 1 is disposed in the center of a motor, a stator 7 is provided to surround the rotor 3 while forming an air gap 5 with the rotor 3, and the stator 7 is provided with a first type 3-phase coil 9 and a second type 3-phase coil 11.

For reference, FIG. 1 shows a partial sector of the motor and the configuration as shown around the rotor 3 may substantially form a complete circle, constituting a single motor.

Hereinafter the second type 3-phase coil 11 may be wound with a smaller number of turns than the first type 3-phase coil 9.

In other words, for example, when the first type 3-phase coil 9 is composed of an A-phase coil AP, a B-phase coil BP, and a C-phase coil CP, and the second type 3-phase coil 11 is composed of an X-phase coil XP, a Y-phase coil YP, and a Z-phase coil ZP, the first type 3-phase coil 9, (i.e., the A-phase coil AP, the B-phase coil BP, and the C-phase coil CP) may be wound with 8 turns respectively, and the second type 3-phase coil 11, (i.e., the X-phase coil XP, the Y-phase coil YP, and the Z-phase coil ZP) may be wound with 4 turns, respectively.

The A-phase coil AP, the B-phase coil BP, and the C-phase coil CP may be sequentially disposed along the circumferential direction of the stator 7, and the X-phase coil XP, the Y-phase coil YP, and the Z-phase coil ZP may be sequentially disposed along a direction in which the A-phase coil AP, the B-phase coil BP, and the C-phase coil CP are disposed.

The first type 3-phase coil 9 disposed at equal intervals along the circumferential direction around the rotation shaft of the motor may form a first partial motor M1 together with the rotor 3, and the second type 3-phase coil 11 disposed at equal intervals along the circumferential direction around the rotation shaft of the motor may form a second partial motor M2 together with the rotor 3.

In other words, the 6-phase motor of the present disclosure may be composed of the first partial motor M1 and the second partial motor M2, and the motor may be driven by applying electric current only to the first type 3-phase coil 9 constituting the first partial motor M1 and may be driven as a 3-phase motor by applying electric current only to the second type 3-phase coil 11 constituting the second partial motor M2.

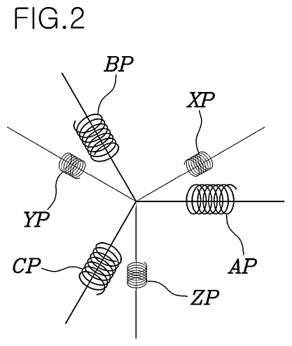

As shown in FIG. 2, the A-phase coil AP, the B-phase coil BP, the C-phase coil CP, the X-phase coil XP, the Y-phase coil YP, and the Z-phase coil ZP may be disposed such that A-phase, X-phase, B-phase, Y-phase, C-phase, and Z-phase are repeatedly formed in order along the circumferential direction of the stator 7.

The first type 3-phase coil 9 and the second type 3-phase coil 11 may be made of windings having different thicknesses.

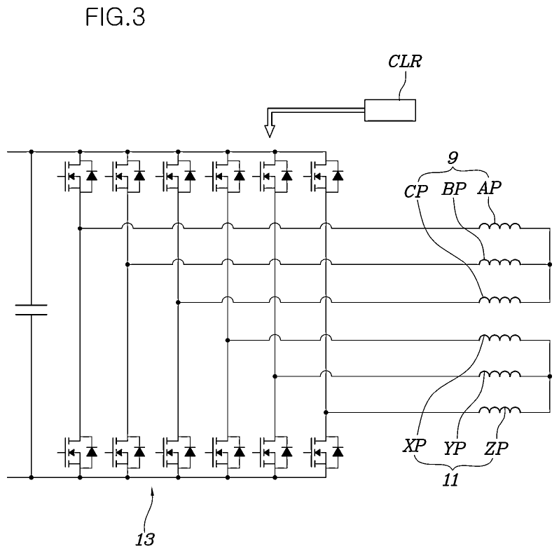

In addition, the 6-phase motor composed of the first type 3-phase coil 9 and the second type 3-phase coil 11 as described above may form a driving circuit as shown in FIG. 3.

In FIG. 3, the 6-phase coil constituting the motor is shown on the right side, and the three in the upper side may consist of the A-phase coil AP, the B-phase coil BP, and the C-phase coil CP constituting the first partial motor M1, the three in the lower side may consist of the X-phase coil XP, the Y-phase coil YP, and the Z-phase coil ZP constituting the second partial motor M2, and an inverter 13 having six legs in order to drive the 6-phase motor is in the left side.

The motor may be driven by controlling switching elements provided in each leg of the inverter 13.

The motor control method of the present disclosure may be implemented by a separate controller CLR that controls the inverter 13.

For reference, the controller CLR in FIG. 3 may be connected to the switching elements of the inverter 13 in order to transmit control commands.

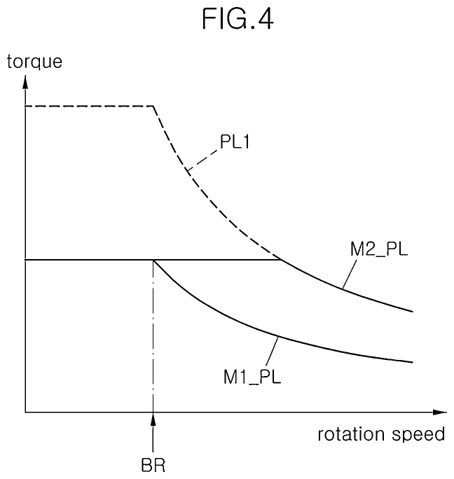

FIG. 4 shows the maximum output lines of the first partial motor M1 and the second partial motor M2 according to the present disclosure, and the maximum output line M1_PL of the first partial motor M1 and the maximum output line M2_PL of the second partial motor M2 are shown. In addition, the maximum output line PL1 connecting the points corresponding to twice the maximum output of the first partial motor M1 is shown together. The maximum output line PL1 may be understood as the maximum output line when the phase angles of the first partial motor M1 and the second partial motor M2 are controlled to be equal as described later.

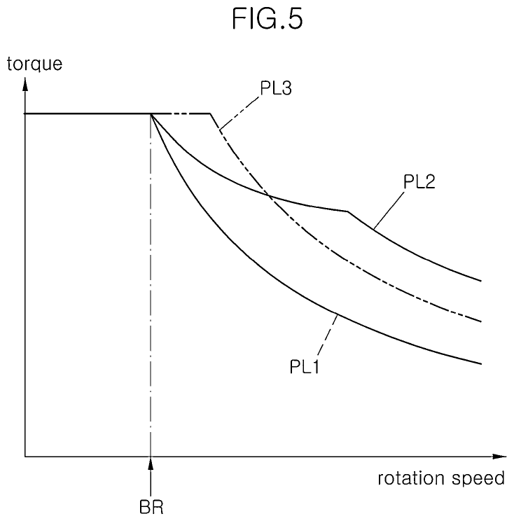

FIG. 5 is a graph comparing simulation results when controlling the phase angles of the first partial motor M1 and the second partial motor M2 to be equal or to be different from each other and the maximum output line PL2 when the phase angles of the first partial motor M1 and the second partial motor M2 are controlled to be different from each other is shown in comparison with the maximum output line PL1 when the phase angles are controlled to be equal.

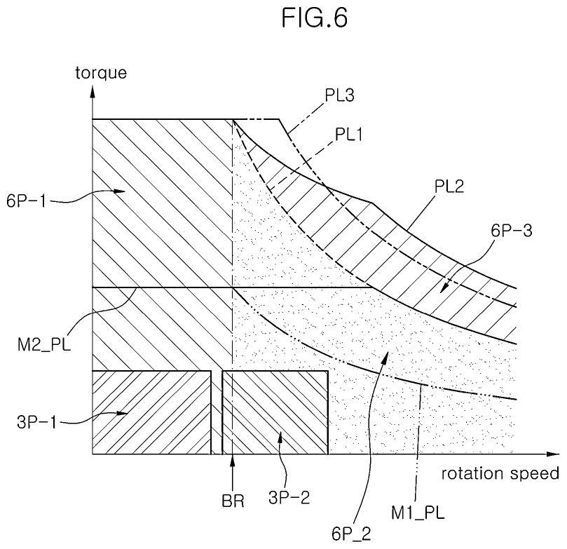

FIG. 6 is a graph explaining the motor control method according to the present disclosure and may show a driving region of the motor according to the present disclosure while showing the maximum output lines of FIGS. 4 and 5 together.

Referring to FIGS. 4-6, the motor control method of the present disclosure may control the phase angles of the first partial motor M1 and the second partial motor M2 to be equal in the rotation speed region where the rotation speed of the 6-phase motor is less than or equal to a predetermined reference rotation speed BR. The term “a rotation speed region” refers to a specific range or zone of rotational speeds within which a motor operates. The first partial motor M1 includes the first type 3-phase coil 9, and the second partial motor M2 includes the second type 3-phase coil 11. The motor control method of the present disclosure may also control the phase angles of the first partial motor M1 and the second partial motor M2 to be different from each other in the rotation speed region where the rotation speed of the 6-phase motor exceeds the reference rotation speed BR.

The reference rotation speed BR may be set to a base rotation speed of the first partial motor M1.

In other words, the phase angles of the first partial motor M1 and the second partial motor M2 may be controlled to be equal in the rotation speed region where the rotation speed of the 6-phase motor is less than or equal to the base rotation speed of the first partial motor M1. The first partial motor M1 has the first type 3-phase coil 9 with a relatively high number of turns. The phase angles of the first partial motor M1 and the second partial motor M2 may be controlled to be different from each other in the rotation speed region where the rotation speed of the 6-phase motor exceeds the base rotation speed, so that the maximum output of the motor may be improved in the rotation speed region exceeding the base rotation speed.

FIG. 5 is a graph of the simulation results comparing the case of controlling the phase angles of the first partial motor M1 and the second partial motor M2 to be equal and the case of controlling the phase angles to be different from each other. It is confirmed that the maximum output line PL2 of the case where the phase angles are controlled to be different from each other may generate a relatively higher maximum output in the rotation speed region exceeding the reference rotation speed BR compared to the maximum output line PL1 of the case where the phase angles are controlled to be equal.

For reference, the maximum output line PL3 may represent the maximum output line of a conventional 6-phase motor in which all 6-phase coils are wound by the number of windings averaging the number of the first type 3-phase coil 9 and the number of the second type 3-phase coil 11.

Accordingly, it may be possible to more easily provide high output performance in the high-speed driving region required by vehicles by controlling the phase angles of the first partial motor M1 and the second partial motor M2 to be different from each other in the rotation speed region exceeding the reference rotation speed BR as described a heterogeneously wound 6-phase motor having the first partial motor M1 and the second partial motor M2 according to the present disclosure.

Controlling the phase angles of the first partial motor M1 and the second partial motor M2 to be equal or to be different from each other may be understood that the phase of the electric current flowing in the A-phase coil of the first partial motor M1 and the phase of the electric current flowing in the X-phase coil of the second partial motor M2 may be equal or different from each other.

Of course, the A-phase coil AP, the B-phase coil BP, and the C-phase coil CP constituting the first partial motor M1 may be supplied with an electrical current with a phase difference of 120° from each other. The X-phase coil XP, the Y-phase coil YP, and the Z-phase coil ZP constituting the second partial motor M2 may be also supplied with an electrical current with a phase difference of 120° from each other.

In FIG. 6, a 6-phase first driving region 6P-1 that may control the phase angles of the first partial motor M1 and the second partial motor M2 to be equal is shown on the left side based on the reference rotation speed BR, and a 6-phase second driving region 6P-2 and a 6-phase third driving region 6P-3 that may control the phase angles of the first partial motor M1 and the second partial motor M2 to be different from each other are shown on the right side.

In a region where the required output of the motor is less than or equal to a predetermined reference output, the output torques of the first partial motor M1 and the second partial motor M2 may be controlled to be equal. In a region where the required output of the motor exceeds the reference output, the output torques of the first partial motor M1 and the second partial motor M2 may be controlled to be different from each other.

The reference output may be set to an output corresponding to twice the maximum output of the first partial motor M1.

In other words, the maximum output line PL1 that connects the points corresponding to twice the maximum output of the first partial motor M1 in FIG. 4 may be a standard for controlling the output torques of the first partial motor M1 and the second partial motor M2 to be equal or to be different from each other.

Controlling the output torques of the first partial motor M1 and the second partial motor M2 to be equal may mean that the output torques of the first partial motor M1 and the second partial motor M2 have a 1:1 relationship.

In other words, in the rotation speed region exceeding the reference rotation speed BR, the region where the required output of the motor is located on the lower side based on the maximum output line PL1 may correspond to the 6-phase second driving region 6P-2 and the region where the required output of the motor is located on the upper side based on the maximum output line PL1 may correspond to the 6-phase third driving region 6P-3.

The reason for controlling as described above is that the Noise Vibration Harshness (NVH) characteristic may deteriorate when the output torques of the first partial motor M1 and the second partial motor M2 are controlled to be equal in a situation where the required output of the motor is higher than the maximum output line PL1. In order to improve the NVH characteristics when driving the motor in the 6-phase second driving region 6P-2, the output torques may be also controlled to be different from each other while the phase angles of the first partial motor M1 and the second partial motor M2 are controlled to be different from each other.

As shown in FIG. 6, the 3-phase second driving region 3P-2 that drives only the second partial motor M2 may be set to a rotation speed region higher than the 3-phase first driving region 3P-1 that drives only the first partial motor M1.

In the end, when the motor of the present disclosure is used as a 3-phase motor, a 3-phase motor may be implemented by driving only the first partial motor M1 in a relatively low rotation speed region, and in a relatively high rotation speed region a 3-phase motor may be implemented by driving only the second partial motor M2.

When a 3-phase motor is implemented by driving only the first partial motor M1 in the 3-phase first driving region 3P-1, which is a relatively low rotation speed region as described above, the number of turns of the first type 3-phase coil 9 constituting the first partial motor M1 may be relatively greater than the number of turns of the second type 3-phase coil 11 constituting the second partial motor M2, so the required electrical current may be reduced, decreasing copper loss when preparing for the same driving point.

In addition, when the 3-phase motor is implemented by driving only the second partial motor M2 in the 3-phase second driving region 3P-2, which is a relatively high rotation speed region as described above, the back electro-motive force may be reduced, decreasing the weak field control loss when preparing for the same driving point.

Although the present disclosure has been shown and described with respect to specific embodiments, it should be self-evident to those of ordinary skill in the art that the present disclosure may be improved and changed in various ways without departing from the technical idea of the present disclosure provided by the following claims.

What is claimed is:

1. A motor control method of controlling, by a controller using an inverter, a six (6)-phase motor with a first type 3-phase coil and a second type 3-phase coil wound with a fewer number of turns than a number of turns of the first type 3-phase coil, the method comprising:
controlling phase angles of a first partial motor and a second partial motor to be equal in a first rotation speed region where a rotation speed of the 6-phase motor is less than or equal to a reference rotation speed, wherein the first partial motor includes the first type 3-phase coil and the second partial motor includes the second type 3-phase coil; and
controlling the phase angles of the first partial motor and the second partial motor to be different from each other in a second rotation speed region where the rotation speed of the 6-phase motor exceeds the reference rotation speed.

2. The motor control method of claim 1, wherein the reference rotation speed is set to a base rotation speed of the first partial motor.

3. The motor control method of claim 1, further comprising:
in a region where a required output of the 6-phase motor is less than or equal to a reference output, controlling output torques of the first partial motor and the second partial motor to be equal; and
in a region where the required output of the 6-phase motor exceeds the reference output, controlling the output torques of the first partial motor and the second partial motor to be different from each other.

4. The motor control method of claim 3, wherein the reference output is set to an output corresponding to twice a maximum output of the first partial motor.

5. The motor control method of claim 1, further comprising:
setting a driving region for driving only the second partial motor to be higher than a driving region for driving only the first partial motor.

6. The motor control method of claim 1, wherein the first partial motor includes the first type 3-phase coil disposed at equal intervals along a circumferential direction around rotation shaft of the 6-phase motor, and
the second partial motor includes the second type 3-phase coil disposed at equal intervals in the circumferential direction around the rotation shaft of the 6-phase motor.

7. The motor control method of claim 6, wherein the first type 3-phase coil is composed of an A-phase coil, a B-phase coil, and a C-phase coil, and
the second type 3-phase coil is composed of an X-phase coil, a Y-phase coil, and a Z-phase coil,
wherein the A-phase coil, the B-phase coil, and the C-phase coil are disposed sequentially in a circumferential direction of a stator, and
the X-phase coil, the Y-phase coil, and the Z-phase coil are sequentially disposed along a direction in which the A-phase coil, the B-phase coil, and the C-phase coil are disposed.

8. The motor control method of claim 7, wherein the A-phase coil, the B-phase coil, the C-phase coil, the X-phase coil, the Y-phase coil, and the Z-phase coil are disposed such that A-phase, X-phase, B-phase, Y-phase, C-phase, and Z-phase are repeatedly formed one by one along the circumferential direction of the stator.

9. The motor control method of claim 6, wherein the first type 3-phase coil and the second type 3-phase coil have different thicknesses.

10. A motor control method of controlling, by a controller using an inverter, a six (6)-phase motor with a first type 3-phase coil and a second type 3-phase coil wound with a fewer number of turns than a number of turns of the first type 3-phase coil, the method comprising:
controlling output torques of a first partial motor and a second partial motor to be equal in a region where a required output of the 6-phase motor is less than or equal to a reference output, wherein the first partial motor includes the first type 3-phase coil and the second partial motor includes the second type 3-phase coil; and
controlling the output torques of the first partial motor and the second partial motor to be different from each other in a region where the required output of the 6-phase motor exceeds the reference output.

11. The motor control method of claim 10, wherein the reference output is set to an output corresponding to twice a maximum output of the first partial motor.

12. The motor control method of claim 11, wherein a driving region for driving only the second partial motor is set to be higher than a driving region for driving only the first partial motor.

13. The motor control method of claim 11, further comprising: in a rotation speed region where a rotation speed of the 6-phase motor is less than or equal to a base rotation speed of the first partial motor, controlling phase angles of the first partial motor and the second partial motor to be equal; and
in a rotation speed region where the rotation speed of the 6-phase motor exceeds the base rotation speed of the first partial motor, controlling the phase angles of the first partial motor and the second partial motor to be different from each other.
